(19) United States
(12) Patent Application Publication
(10) Pub. No.: US 2013/0188922 A1
(43) Pub. Date: Jul. 25, 2013

(54) Multimedia File Support for Media Capture Device Position and Location Timed Metadata

(71) Applicants: David Stuart Furbeck, Keller, TX (US); Rene Waraputra Purnadi, Irving, TX (US); Gaelle Christine Martin-Cocher, Toronto (CA)

(72) Inventors: David Stuart Furbeck, Keller, TX (US); Rene Waraputra Purnadi, Irving, TX (US); Gaelle Christine Martin-Cocher, Toronto (CA)

(73) Assignee: RESEARCH IN MOTION LIMITED, Waterloo (CA)

(21) Appl. No.: 13/356,409

(22) Filed: Jan. 23, 2012

(51) Int. Cl. H04N 9/80

(52) U.S. Cl. 386/239; 386/E09.011

(57) ABSTRACT

A method is provided for recording data. The method comprises recording, by a device, a first set of samples of at least one of video data or audio data and recording, by the device, a second set of samples of information related to at least one of a position of the device or an orientation of the device. A plurality of samples in the first set are associated with a plurality of samples in the second set.

### BACKGROUND

Many smartphones, feature phones, tablets, digital cameras, and similar devices are equipped with a global positioning system (GPS) or other location sensing receivers, accelerometers, or digital compasses. Such components can sense the location, direction, and rotation of the devices in which they are installed. Such devices may also be equipped with cameras that can record coordinated video and audio information.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a definition of the abstract class “box”, according to the prior art.

FIG. 2 illustrates ISO file format box types and structure, according to the prior art.

FIG. 3 illustrates the ISO file format box structure hierarchy, according to the prior art.

FIG. 4 illustrates SDL code for the sample description box, according to the prior art.

FIG. 5 illustrates SDL code for abstract classes that extend the abstract class SampleEntry, according to the prior art.

FIG. 6 illustrates classes that extend the MetaDataSampleEntry class, according to the prior art.

FIG. 7 illustrates a system architecture for adaptive HTTP streaming, according to the prior art.

FIG. 8 illustrates the concepts of pan, tilt, and rotation, according to the prior art.

FIG. 9 illustrates a class that extends the MetaDataSampleEntry class, according to an implementation of the disclosure.

FIG. 10 illustrates an XML schema that defines a sample according to an implementation of the disclosure. The schema can be referenced by an instance of the XMLMetaDataSampleEntry class.

FIG. 11 illustrates possible changes that could be made to an existing standard according to an embodiment of the disclosure.

FIG. 12 is a flowchart for a method for recording data, according to an implementation of the disclosure.

FIG. 13 illustrates a processor and related components suitable for implementing the present disclosure.

### DETAILED DESCRIPTION

It should be understood at the outset that although illustrative examples of one or more implementations of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

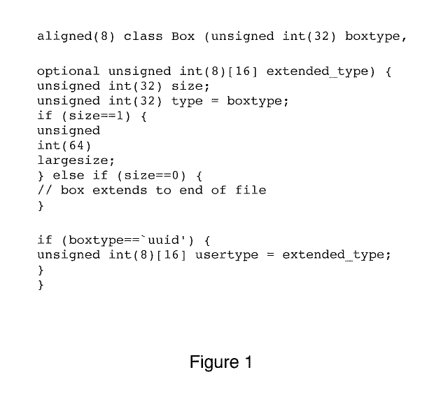

The Third Generation Partnership Project (3GPP) File Format is based on the International Organization for Standardization/International Electrotechnical Commission (ISO/IEC) 14496-12 ISO Base Media File Format. The 3GPP file structure is object oriented. As with object-oriented programming languages, all objects in the 3GPP file structure are instances of a blueprint in the form of a class definition. Files consist of a series of objects called boxes, which are object-oriented building blocks characterized by a unique type identifier and length. The format of a box is determined by its type. Boxes can contain media data or metadata and may contain other boxes. Each box begins with a header that contains its total size in bytes (including any other boxes contained within it) and an associated box type (typically a four-character name). The class definitions are given in the syntax description language (SDL). The definition of the abstract class “Box” is given in FIG. 1.

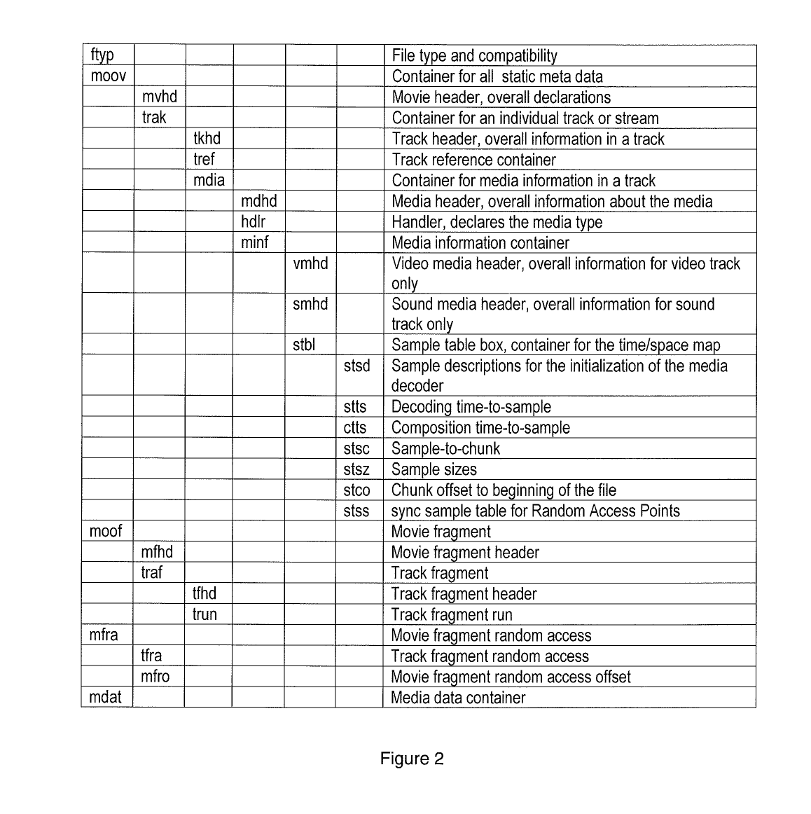

All other classes are derived from “Box” using the concept of inheritance familiar in object-oriented programming. The “movie box” contains sub-boxes that define the static metadata for a presentation, where a presentation is one or more motion sequences, possibly combined with audio. The actual media data for a presentation is contained in the “media data box”. Within the movie box are one or more “track boxes”, which each correspond to a single track of a presentation. Tracks are timed sequences of related samples. For example, one track box may contain metadata for video and another track box may contain metadata for audio. Within each track box is a “media box”, which contains, among other things, information about the timescale and duration of a track. The media box, despite its name, is purely metadata and should not be confused with the media data box. Also contained within the media box is the “sample table box”, which is a box with a packed directory for the timing and physical layout of the samples in a track. A sample is all of the data associated with one time stamp. So, for example, a sample described by a video track might be one coded frame of video, a sample described by an audio track might be ten coded speech frames, etc. For the case of a timed metadata track, a sample is the metadata associated with one time stamp. The sample table box also contains codec information. If the media data exists prior to the creation of the movie box, then the sample table typically contains all of the timing and sample location information necessary to render the presentation. Some of the boxes in the 3GPP file format are shown in FIG. 2.

In live streaming use cases, it may not be possible to write all of the metadata about the entire media stream prior to the creation of the movie box because that information may not be known yet. Also, if there is less overhead at the beginning of the file, startup times can be quicker. For these reasons, the ISO base media file format (and hence the 3GPP file format through inheritance) allows the boxes to be organized as a series of metadata/media data box pairs called “movie fragments”. In this way, the file can be written on the fly to accommodate a live stream.

Inside the media box is a “handler reference box”, whose main purpose is to indicate a “handler_type” for the media data in the track. The currently supported handler_types are ‘vide’ for a video track, ‘soun’ for an audio track, ‘hint’ for a hint track (which provides instructions on packet formation to streaming servers), and ‘meta’ for a timed metadata track.

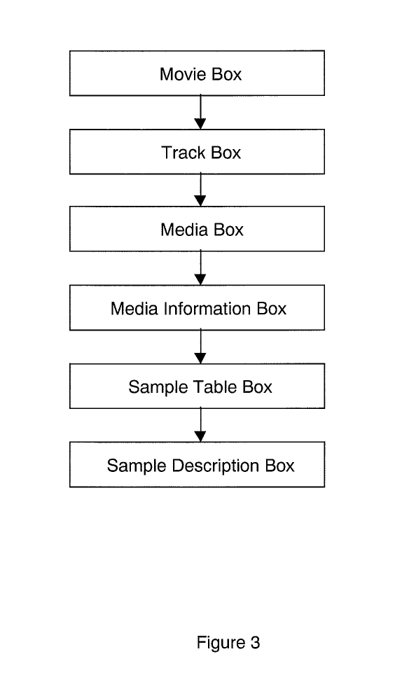

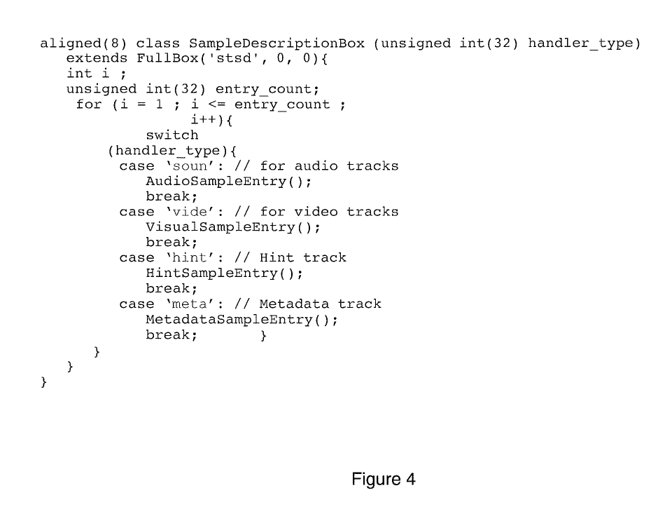

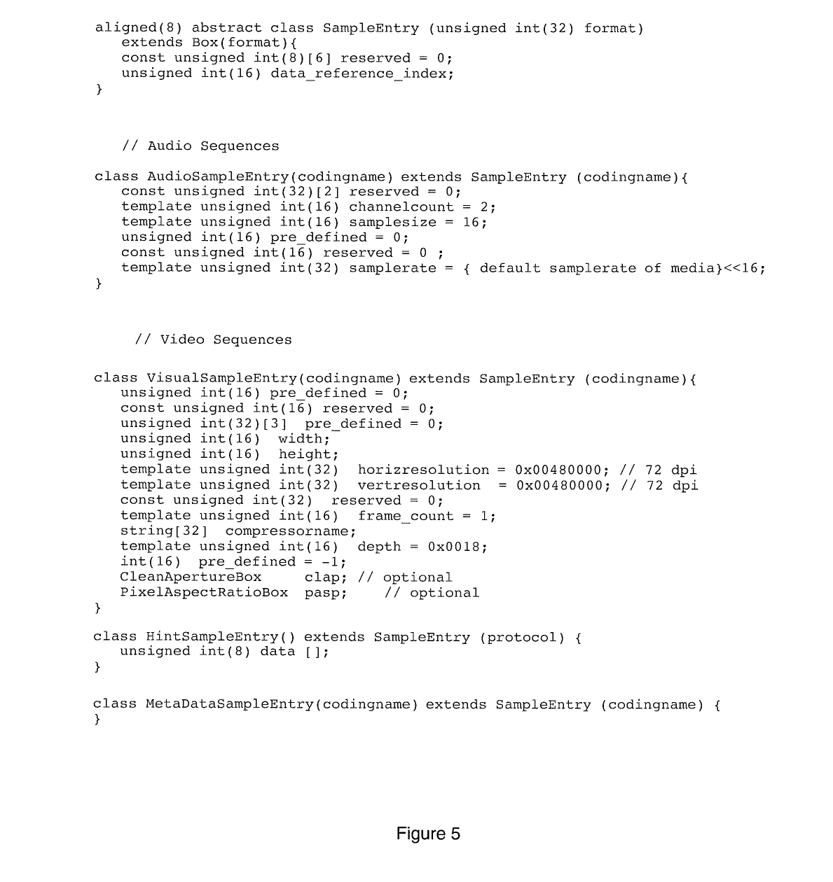

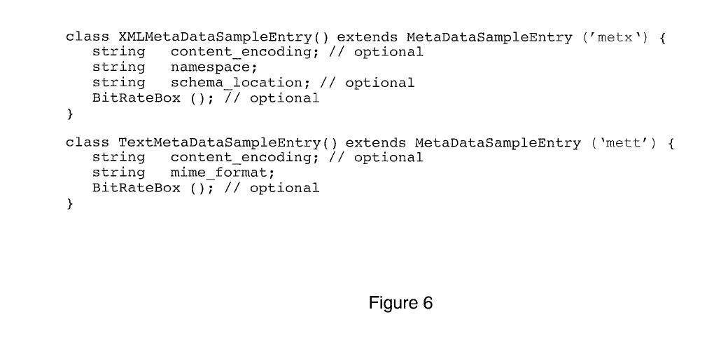

FIG. 3 shows the hierarchy of some of the boxes discussed thus far. One of the boxes within the sample table box is the “sample description box”. The SDL code for the sample description box is given in FIG. 4. AudioSampleEntry, VisualSampleEntry, HintSampleEntry, and MetadataSampleEntry are abstract classes which extend the abstract class SampleEntry. The SDL code for these is given in FIG. 5. Any particular codec would extend these classes. For example, 3GPP Technical Specification (TS) 26.244 defines AMRSampleEntry, H263 SampleEntry, AVCSampleEntry, etc. The only currently defined classes which extend MetaDataSampleEntry are shown in FIG. 6.

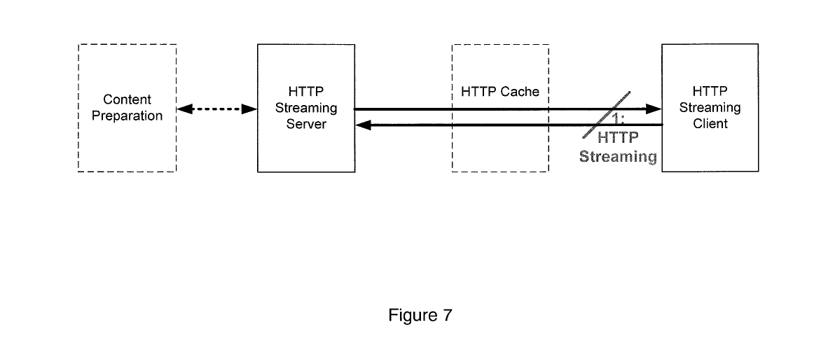

One of the applications that makes use of the ISO Base Media File Format/3GPP File Format is 3GPP Dynamic and Adaptive Streaming over HTTP (3GPP-DASH) and MPEG DASH. An HTTP Streaming client can use HTTP GET requests to download a media presentation. The presentation is described in an XML document called a Media Presentation Description (MPD). From the MPD the client can learn in what formats the media content is encoded (e.g., bitrates, codecs, resolutions, and languages). The client then chooses a format based, for example, on characteristics of the client device, such as screen resolution, channel bandwidth of the client, or channel reception conditions, or based, for example, on information configured in the client by the user, such as language preference. The system architecture from the 3GPP Specification is shown in FIG. 7.

A Media Presentation consists of one or more Periods. The Periods are sequential and non-overlapping. That is, each Period extends until the start of the next Period. Each Period consists of one or more Representations. A Representation is one of the alternative choices of the media content or a subset thereof, typically differing by bitrate, resolution, language, codec, or other parameters. Each Representation consists of one or more Segments. Segments are the downloadable portions of media and/or metadata, whose locations are indicated in the MPD.

Many types of devices, such as video cameras, camera phones, smart phones, personal digital assistants, tablet computers, and similar devices can record video and/or audio information. Some such devices might record only video information or only audio information, but the discussion herein will focus on devices that can record both video and audio. Any such apparatus that can record video and/or audio information will be referred to herein as a device. In some example embodiments described herein, the term “camera” may be used. However, it is to be understood that the present disclosure applies more generically to devices.

A device might be able to tag recorded information with location data. That is, a file containing video and/or audio information might be associated with metadata that describes the device's geographic position at the time the file was created. The geographic position information might be determined by a GPS system or a similar system. Such metadata is typically static, constant, or otherwise not subject to change. That is, only a single instance of the metadata can be associated with a file containing video and/or audio information.

Implementations of the present disclosure can associate time stamps with both position-related parameters and orientation-related parameters detected by a device. That is, in addition to recording position-related information, such as latitude, longitude, and/or altitude, a device can record orientation-related information, such as pan, rotation, tilt and/or zoom as discussed in detail below. A plurality of samples of the position-related information and the orientation-related information can be recorded continuously throughout the creation of a video and/or audio recording, and the samples can be time stamped. In various embodiments, orientation-related information may be recorded as static information for the duration of the video and/or audio recording. The samples might be recorded in a metadata track that can be associated with the video and audio tracks. Support for this position-related and orientation-related metadata can be integrated into the ISO base media file format or into a file format based on the ISO base media file format such as a 3GPP or MP4 file. It can then be possible to record this information in the video file format so that this information can be used in processing the video and/or while displaying the video.

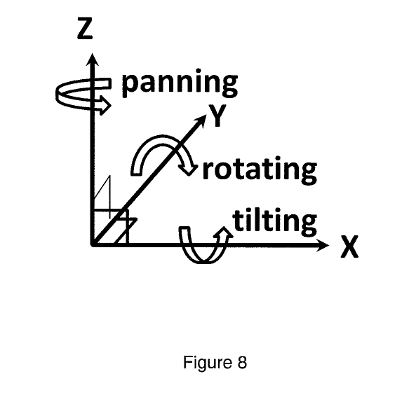

FIG. 8 illustrates the concepts of Pan, Tilt, and Rotation. In certain cases only a subset of these parameters may be relevant. For example, a Rotation parameter value may or may not be relevant for a directional microphone. In the figure, the x-y plane is parallel to the Earth's surface and the z axis is perpendicular to the Earth's surface at the camera location (i.e., the positive z direction points towards the sky). Any vector pointing in the direction that the camera is facing will have a component vector in the x-y plane and another along the z-axis. The only exception to there being a component in the x-y plane is the case where the camera is pointing either straight down at the ground or straight up towards the sky. In this exceptional case, the Pan value is undefined and does not need to be included in the sample orientation parameters. Assuming that the component vector in the x-y plane does exist, its direction defines the positive y-axis. In other words, the compass direction component of any vector pointing in the direction that the camera is facing is the direction of the positive y-axis. In this case, the Pan value can be defined as the amount of counter-clockwise (or alternatively clockwise) rotation about the z axis needed to bring a vector initially pointing towards a fixed reference direction in the x-y plane (for example East) into alignment with the y-axis. The Rotation value corresponds to the camera's rotational position about the axis in the direction that the camera is facing. The Tilt value corresponds to the rotational position of the camera about the x-axis (the x-axis being defined as shown perpendicular to the y-axis and the z-axis). Since the Rotation and Tilt are independent parameters, the Rotation value can be defined without loss of generality for the case where the direction that the camera is facing corresponds to a vector in the x-y plane (i.e. zero tilt). If this were not the case, then the camera could first be rotated about the x-axis or “tilted” to be in the x-y plane without affecting the value of the Rotation parameter. Assuming zero tilt, then the Rotation can therefore be defined as the amount of counter-clockwise (or alternatively clockwise) rotation about the y-axis needed to bring a vector initially pointing along the positive z-axis into alignment with the camera “up” direction. Similarly, the Tilt can be defined as the amount of counter-clockwise (or alternatively clockwise) rotation about the x-axis needed to bring a vector initially pointing along the positive y-axis into alignment with the direction that the camera is facing. For the exceptional case that the camera is pointing straight up towards the sky or straight down towards the ground, the Pan value is not defined. In this case Rotation can be defined as the amount of counter-clockwise rotation about the z-axis needed to bring a vector initially pointing towards a fixed reference direction in the x-y plane (for example East) into alignment with the camera “up” direction.

As well as the parameters defined previously, a Zoom parameter might also be defined. This could indicate the amount of optical zoom and/or digital zoom associated with images from the camera. This might also include a horizontal and/or vertical component to the zoom and might further include a horizontal and/or vertical position within the image to center the zoom. The zoom might also be centered on a GPS location in the image. The zoom might by default apply to the whole image, but might apply to part of the image. One of ordinary skill in the art will recognize that there are numerous possible realizations of the Zoom parameter. As one example, Zoom can be a 32 bit parameter consisting of a fixed-point 8.8 number indicating the amount of optical zoom followed by an 8.8 number indicating the amount of digital zoom. In this disclosure Zoom is to be understood as one of the possible parameters included in the category “orientation parameters”. In other words, the level of Zoom may constitute a parameter within the category “orientation parameters”.

As an example, a photographer may rotate a device (from portrait to landscape, for instance) while recording a video. Previously, there would be no indication of the orientation of the device in the 3GPP file that would be recorded. If the photographer sent a recording made while a device was being rotated to another person, there would be no easy way for the other person's device to compensate for the rotation.

In an implementation, information about the rotation is recorded in a file, and the other person's device can perform a compensatory rotation of the video prior to rendering. Alternatively, the other person's device can provide an indication of rotation, such as an arrow indicating the direction of “up” so that the other person can follow the change of the first device's rotation by following the indication.

Similarly, any change detected in a device's position or orientation can be recorded in the file. This can enable video to be processed (either in real time or offline) so that the camera position appears to be stable. For example, during a police chase, the camera on the dashboard of the police car can bounce around. In an implementation, such movement can be detected via an accelerometer or a similar component, and then the video can be processed so that the camera position appears stable, possibly with an additional step of cropping.

The location of the device while the video and/or audio is being recorded can also be of use. For example, if video is recorded from a car, plane, or other moving vehicle, a map can be displayed alongside the video with an indication of the device's position on the map and possibly the camera orientation. This position might change as the video sequence moves forward or backward in time.

Implementations of the present disclosure add a box that defines the format of metadata samples, the samples including parameters that describe a device's position and/or orientation. The samples might include Latitude, Longitude, Altitude, Pan, Tilt, and/or Rotation. Any combination of these parameters might be included. Pan and Tilt would correspond to the relevant direction for media capture (i.e., the direction the camera is facing or the direction of a directional microphone). In the case of an omni-directional microphone Pan, Tilt, and Rotation might not be present. Alternatively, for a device having a display, these parameters might be defined to correspond to the direction perpendicular to the plane of the display in the direction into the device in the case where there is no camera and no relevant direction for audio capture. By adding this box as an extension of the “MetaDataSampleEntry” box defined in the ISO base media file format, all of these parameters can be recorded into a file as timed metadata within the media data box. Alternatively, an extensible markup language (XML) schema and namespace can be defined externally which contains these parameters, and the samples can be XML, binary XML, or some other compressed format.

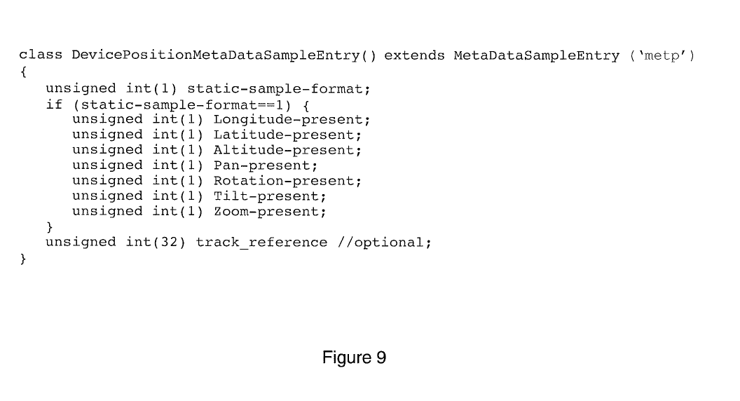

When a box is added directly to the file format, support for the position and/or orientation parameters can be defined as part of the file format. There is no need to use an XML parser to parse XML that is defined elsewhere. More specifically, the MetaDataSampleEntry class can be extended with a class called DevicePositionMetaDataSampleEntry as shown in FIG. 9. One of skill in the art will recognize that other class names or variable names could be used for this or a similar class.

FIG. 9 shows an example definition of DevicePositionMetaDataSampleEntry. The box might be defined to contain a variable called static-sample-format. If static-sample-format is set to ‘1’, then all samples have the same format and which parameters are present in the sample is determined by the values of Longitude-present, Latitude-present, Altitude-present, Pan-present, Rotation-present, Tilt-present, and Zoom-present. If static-sample-format is equal to ‘0’, then Longitude-present, Latitude-present, Altitude-present, Pan-present, Rotation-present, Tilt-present, and Zoom-present are present in the sample itself. If these are present in each sample, then the sample format is dynamic in the sense that it might vary from sample to sample. For example, Latitude-present might be set to ‘1’ in one sample (indicating that the parameter Latitude is present in that sample), but might be set to ‘0’ in another sample. If a particular parameter is not present in a sample, it could be defined to mean that the value is the same as the last sample in which the parameter was present or it could be defined to mean that there is no information about the parameter in this sample. The following definitions can apply to the parameters shown in FIG. 9. Longitude-present can be set to ‘1’ if the parameter Longitude is present in samples of this track and ‘0’ otherwise. Similarly, Latitude-present can be set to ‘1’ if the Latitude is present in samples of this track and ‘0’ otherwise. Altitude-present can be set to ‘1’ if Altitude is present in samples of this track and ‘0’ otherwise. Pan-present can be set to ‘1’ if Pan is present in samples of this track and ‘0’ otherwise. Rotation-present can be set to ‘1’ if Rotation is present in samples of this track and ‘0’ otherwise. Tilt-present can be set to ‘1’ if Tilt is present in samples of this track and ‘0’ otherwise. Finally, Zoom-present can be set to ‘1’ if Zoom is present in samples of this track and ‘0’ otherwise.

The order of the parameters (Longitude, Latitude, Altitude, Pan, Rotation, and Tilt) present in a sample should be specified and can, for example, correspond to the order of Longitude-present, Latitude-present, Altitude-present, Pan-present, Rotation-present, and Tilt-present in the instance of DevicePositionMetaDataSampleEntry. The order of Longitude-present, Latitude-present, Altitude-present, Pan-present, and Tilt-present may also need to be specified for the case that static-sample-format is equal to ‘0’. Longitude can be a fixed-point 16.16 number indicating the longitude in degrees. Negative values can represent western longitude. Latitude can be a fixed-point 16.16 number indicating the latitude in degrees. Negative values can represent southern latitude. Altitude can be a fixed-point 16.16 number indicating the altitude in meters. The reference altitude, indicated by zero, can be set to sea level.

Pan can be a fixed-point 16.16 number measured in degrees and defined as previously described herein. East can be represented by 0 degrees, North by 90 degrees, South by −90 degrees, etc. Rotation can be a fixed-point 16.16 number indicating the angle of rotation in degrees about the y axis as shown in FIG. 8 and described previously herein. Tilt can be a fixed-point 16.16 number indicating the angle in degrees at which the device is tilted about the x axis as shown in FIG. 8 and described previously herein.

The position and/or orientation parameters above can correspond to individual tracks of media. For example, as will be described in more detail below, video can be recorded from a central location with a certain camera position/orientation and audio tracks may be recorded from another position or recording orientation (for example using directional microphones in different locations). In such a case, the media track whose media capture device (camera, microphone, etc.) position and orientation is the one being recorded in the metadata samples can be indicated by its track_ID with a track reference parameter. Such a parameter might be referred to as “track_reference”. track_reference could be included in the DevicePositionMetaDataSampleEntry Box. There could be multiple of these boxes per file (for example if there were one video and two audios all recorded from different positions). If the “track_reference” is not defined or present, the parameters might apply by default to all tracks or to only the video track, etc.

Instead of “Longitude-present”, “Latitude-present”, and the other presence-related parameters given in FIG. 9, the presence of such parameters might be inferred from the length of the sample. In this case, the order of the parameters might be fixed, and the total size of the sample would indicate which parameters, either from the beginning of the list or the end of the list, were or were not present.

The values of the parameters can indicate the absolute position and/or orientation of the device. Alternatively, the parameters might be defined to indicate a relative change in position and/or orientation of the device. This relative change in position and/or orientation of the device might also have an associated time duration that indicates that the relative change is applied for a finite length of time.

One of ordinary skill in the art will recognize that there are many essentially equivalent ways to define the position and orientation parameters and that the parameters can be represented with varying precision. For example, the orientation parameters can be defined linearly in terms of degrees, but can also be defined with minutes ( 1/60 of a degree), seconds ( 1/60 of a minute), etc. Instead of degrees, radians might be used. The rotation which is called 0 degrees is also somewhat arbitrary. For example, it may correspond to portrait or landscape orientation or to some other orientation. Also, angles in degrees can be defined as being between 0 and 360 degrees, between −180 to 180 degrees, or between some other values.

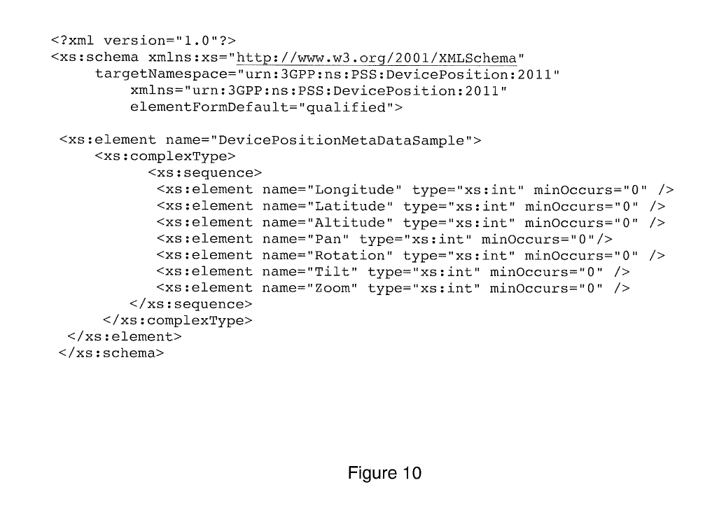

In an alternative implementation, the existing XMLMetaDataSampleEntry box can be used to indicate an XML schema and namespace which are defined outside the 3GPP file format. That is, the XMLMetaDataSampleEntry box, which is already defined in the ISO base media file format, could be used to link to a namespace, and the schema for that namespace could be defined outside the file format. An example schema defining a sample containing at least one of Longitude, Latitude, Altitude, Pan, Rotation, Tilt, or Zoom is shown in FIG. 10. A person of ordinary skill in the art will recognize that there are many equivalent or nearly equivalent forms the XML schema could take.

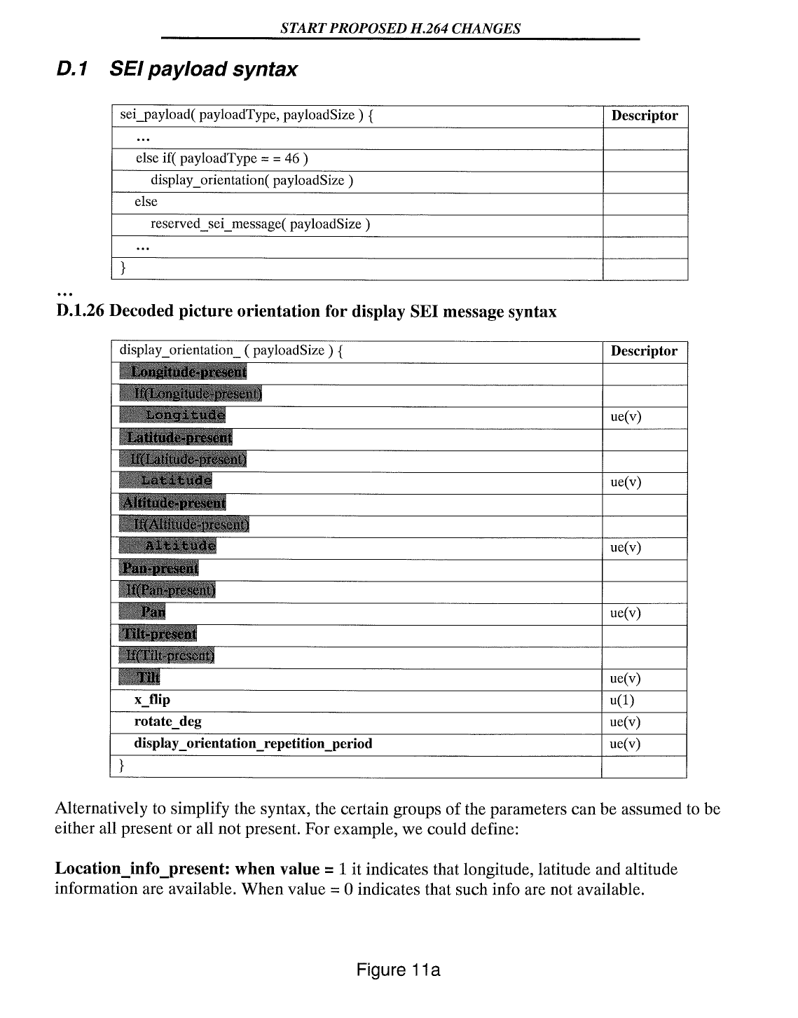

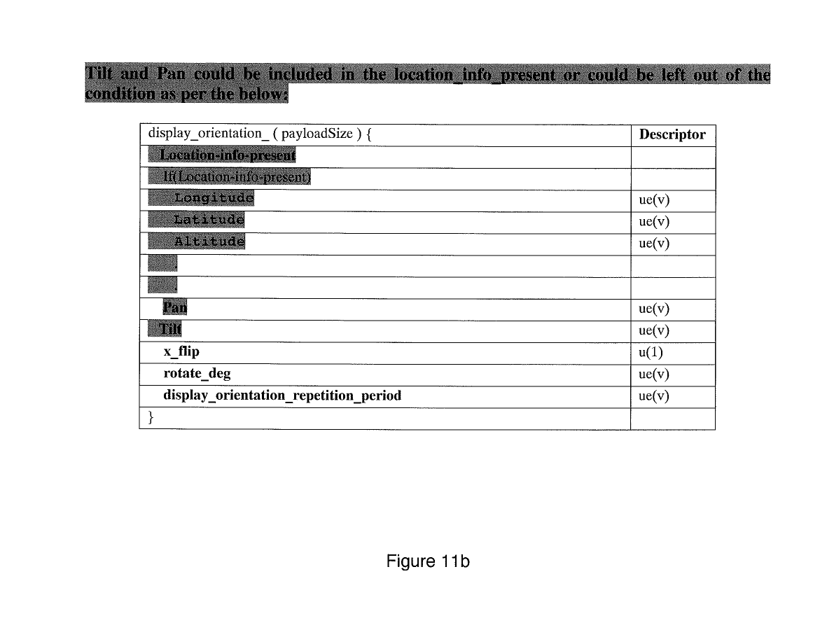

In an alternative implementation, an H.264/High Efficiency Video Coding (HEVC) SEI (Supplementary Enhancement Information) message can be created or an existing such message can be modified to integrate the device's position and orientation information. Such a message might be the one defined in “T09-SG16-C-0690!R1!MSW-E, STUDY GROUP 16—CONTRIBUTION 690R1—H.264 & H.HEVC: SEI message for display orientation information”. Possible changes that could be made to that document in such an implementation are shown in FIGS. 11a and 11b, with the possible changes highlighted.

In the current SEI message referenced above, a display_orientation_repetition_period parameter specifies the persistence of the display orientation characteristic message. In one embodiment, the display orientation repetition period parameter is extended to also specify the persistence of at least one of the altimeter, location information, tilt information or pan information. In another embodiment, regardless of whether the altimeter, location, tilt and/or pan information are part of the same SEI message, an independent parameter such as a location_info_repetition_period or an altimeter_info_repetition period can be defined to specify the persistence of the information. The value of such a parameter can be set equal to zero to specify that this information applies to the current picture/sample. The value of such a parameter can be set equal to 1 to specify that this information persists until a new coded sequence starts or a new SEI message containing such a parameter is made available.

In an embodiment, a zoom parameter is added to an SEI message, along with the rotation parameters and/or along with the location information parameters or any combination thereof. The zoom parameter can be provided as a specific SEI message. The zoom parameter could include the zoom value and the length of the duration of the zoom process. The zoom parameter might include values such as zoom-width, zoom-height, zoom-position, zoom-align, and/or zoom-distance.

In an implementation, a plurality of metadata tracks, each containing multiple samples of position and/or orientation information, can be recorded. For example, if the video recording component and the audio recording component of a device are spatially separated from one another, it may be useful to record position and/or orientation information for the video information in a first metadata track and record position and/or orientation information for the audio information in a second metadata track. Similarly, a device might include a plurality of microphones to record, for instance, a left audio channel and a right audio channel. In an implementation, separate metadata tracks could record position and/or orientation information for each of the audio channels.

In an implementation, a device can stream or upload the position and/or orientation information that it records to a network (for example to an HTTP server). In the case of HTTP Streaming, a device might also upload the corresponding changes to an MPD by transmitting MPD Delta Files as defined in 3GPP TS 26.247 to the server. The MPD Delta files from different users can then be used on the server side to construct the MPD (and possibly MPD Delta files for download by HTTP Streaming clients) for a particular event. Since the times when devices start recording may not be synchronized, the MPD might indicate a time offset of a particular Representation from the start of a Period, or the HTTP Streaming server might not make the content available for download as part of an MPD until a Period boundary. The server might make information available to devices about specific times to start recording so that device start times are synchronized. Devices could record with movie fragments or the server could reformat the uploaded or streamed content into movie fragments so that it is compatible with 3GPP-DASH or MPEG-DASH. If the position and/or orientation parameters are streamed or uploaded to a network, then the network can make the information available to users that have access to the network. The users could then use that information to find video and/or audio tracks that may be of interest. For example, one or more photographers might make multiple recordings of the same public event and send the video, audio, and metadata tracks of the recordings to a network. A network user might search the metadata tracks of one or more of the recordings to find associated video and/or audio tracks that were recorded at a desired geographic location. The tracks recorded at that location might then be searched to find tracks with a desired spatial orientation. The network user might then choose to play back a first recording of the public event made at a first time by a first device with a first position and/or orientation and then play back a second recording of the event made at a later time by a second device with a second position and/or orientation. In this way, the user might create a customized view of the entire event by choosing to view the event from different locations and with different orientations at different times.

The position and/or orientation (including the Level of Zoom) of a device that is recording media can be indicated in a Media Presentation Description file, and clients can select Representations based on this information (i.e., the position and orientation information). With the ability to record this information with time stamps in the file as timed metadata, the Media Presentation Description file could even provide this information on a Segment basis or a sub-Segment basis. Clients could then use this information to decide which Representations, Segments, and/or sub-Segments of the content to download. One application of this would be that if multiple users are recording the same event from different locations and/or orientations (for example, a concert or sports event), the different recordings could be uploaded to an HTTP Streaming server. HTTP Streaming clients might then decide which view to download based on the location and/or position of the camera or audio recording device. For example, if a client knows that a goal was scored at a hockey game, the client might want to switch to a Representation showing a view closer to the net that the goal was scored on or one in which the level of Zoom is more desirable. On the other hand, if a fight breaks out at center ice, the client might want to switch to a Representation closer to center ice. The Representations could be streamed live from devices at the event, or the Representations could be recorded and then uploaded, for example from people on their cell phones uploading the content to a server.

Users could go to a website and select relevant instances of interest at a particular event, and the corresponding times and/or locations for these instances could be downloaded to the user's client device. For example, a user might select instances of dunks in a basketball game or blocks or instances where a particular player scored, etc. The user might be presented with a checklist where they could check multiple types of instances that they are interested in. By downloading the time and position and/or orientation of these relevant instances, the user might decide which Segments or Representations to download if the Segments or Representations contain information relevant to viewing the instance of interest (for example the position and/or orientation from which the event was recorded). The server might also customize the MPD or content for the user based on their selections.

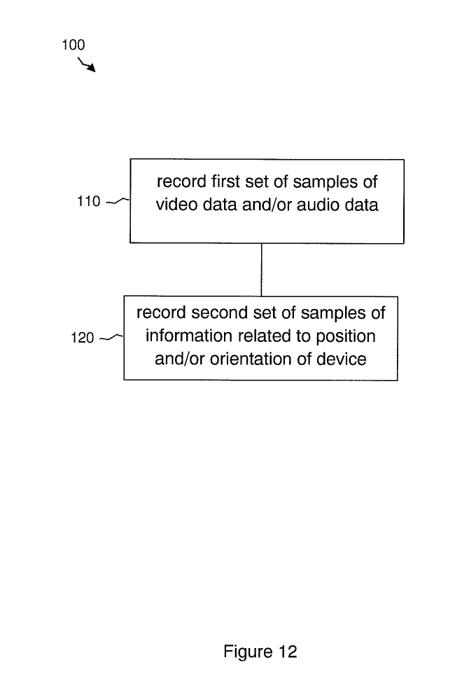

FIG. 12 illustrates an implementation of a method 100 for recording data. At box 110, a device records a first set of samples of at least one of video data or audio data. At box 120, the device records a second set of samples of information related to at least one of a position of the device or an orientation of the device. A plurality of samples in the first set might be associated with a plurality of samples in the second set. It should be understood that the recording steps do not necessarily occur sequentially as shown. The recording of the first set of samples and the recording of the second set of samples might occur substantially simultaneously.

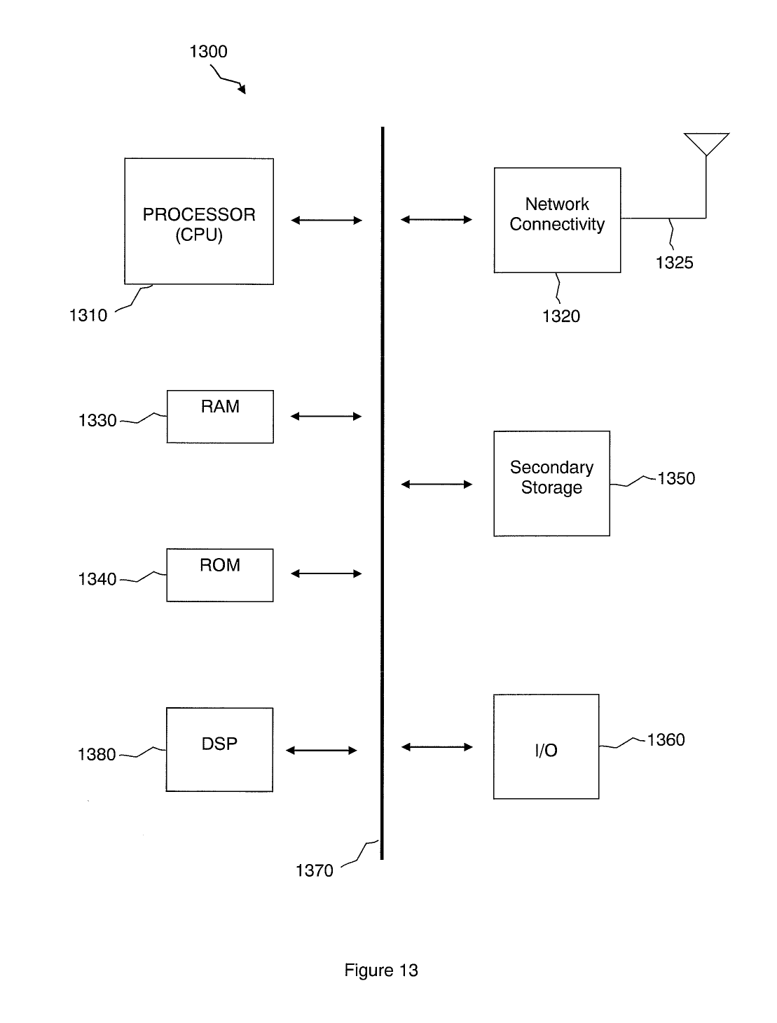

The device described above might include a processing component that is capable of executing instructions related to the actions described above. FIG. 13 illustrates an example of a device 1300 that includes a processing component 1310 suitable for one or more of the implementations disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, digital subscriber line (xDSL) devices, data over cable service interface specification (DOCSIS) modems, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver component 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

In an implementation, a method is provided for recording data. The method comprises recording, by a device, a first set of samples of at least one of video data or audio data and recording, by the device, a second set of samples of information related to at least one of a position of the device or an orientation of the device. A plurality of samples in the first set are associated with a plurality of samples in the second set.

In another implementation, a device is provided. The device comprises a processor configured such that the device records a first set of samples of at least one of video data or audio data. The processor is further configured such that the device records a second set of samples of information related to at least one of a position of the device or an orientation of the device. A plurality of samples in the first set are associated with a plurality of samples in the second set.

In another implementation, a method is provided for recording data. The method comprises recording, by a device, a first set of samples of at least one of video data and audio data and recording, by the device, at least one sample of information related to a position of the device and to an orientation of the device. The at least one sample of information related to the position of the device and the orientation of the device is associated with at least one of the samples of at least one of video data and audio data.

The following are incorporated herein by reference for all purposes: 3GPP TS 26.244, 3GPP TS 26.247, and ISO/IEC 14496-12.

While several implementations have been provided in the present disclosure, it should be understood that the disclosed systems and methods may be implemented in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for recording data, the method comprising:
recording, by a device, a first set of samples of at least one of video data or audio data; and
recording, by the device, a second set of samples of information related to at least one of a position of the device or an orientation of the device, wherein a plurality of samples in the first set are associated with a plurality of samples in the second set.

2. The method of claim 1, further comprising storing the first set of samples in a file that conforms with at least one of:
an International Organization for Standardization (ISO) base media file format; and
a file format based on the ISO base media file format.

3. The method of claim 2, wherein the first set of samples are described in a box that is an extension of the MetaDataSampleEntry box defined in the ISO base media file format.

4. The method of claim 1, further comprising defining the format of the first set of samples by an extensible markup language (XML) schema.

5. The method of claim 1, wherein the first set of samples and the second set of samples are transmitted to a network.

6. The method of claim 1, wherein a first portion of the second set of samples contains audio-related metadata and is stored in a first metadata track, and wherein a second portion of the second set of samples contains at least one of video-related metadata or additional audio-related metadata and is stored in a second metadata track.

7. The method of claim 6, wherein the first metadata track is referenced by a first track number and the second metadata track is referenced by a second track number, and wherein the first and second track numbers are stored in a box that is an extension of the MetaDataSampleEntry box defined in the ISO base media file format.

8. The method of claim 1, wherein at least one of the position of the device and the orientation of the device are recorded in a Media Presentation Description file.

9. The method of claim 1, wherein at least one of the position of the device and the orientation of the device are recorded in the Supplementary Enhancement Information (SEI) of a video coding format.

10. A device, comprising:
a processor configured such that the device records a first set of samples of at least one of video data or audio data and further configured such that the device records a second set of samples of information related to at least one of a position of the device or an orientation of the device, wherein a plurality of samples in the first set are associated with a plurality of samples in the second set.

11. The device of claim 10, wherein the device stores the first set of samples in a file that conforms with at least one of:
an International Organization for Standardization (ISO) base media file format; and
a file format based on the ISO base media file format.

12. The device of claim 11, wherein the first set of samples are described in a box that is an extension of the MetaDataSampleEntry box defined in the ISO base media file format.

13. The device of claim 10, further comprising defining the format of the first set of samples by an extensible markup language (XML) schema.

14. The device of claim 10, wherein the first set of samples and the second set of samples are transmitted to a network.

15. The device of claim 10, wherein a first portion of the second set of samples contains audio-related metadata and is stored in a first metadata track, and wherein a second portion of the second set of samples contains at least one of video-related metadata or additional audio-related metadata and is stored in a second metadata track.

16. The device of claim 15, wherein the first metadata track is referenced by a first track number and the second metadata track is referenced by a second track number, and wherein the first and second track numbers are stored in a box that is an extension of the MetaDataSampleEntry box defined in the ISO base media file format.

17. The device of claim 10, wherein at least one of the position of the device and the orientation of the device are recorded in a Media Presentation Description file.

18. The device of claim 10, wherein at least one of the position of the device and the orientation of the device are recorded in the Supplementary Enhancement Information (SEI) of a video coding format.

19. A method for recording data, the method comprising:
recording, by a device, a first set of samples of at least one of video data and audio data; and
recording, by the device, at least one sample of information related to a position of the device and to an orientation of the device, wherein the at least one sample of information related to the position of the device and the orientation of the device is associated with at least one of the samples of at least one of video data and audio data.

20. The method of claim 19, further comprising recording a plurality of samples of information related to the position of the device and the orientation of the device and associating the plurality of samples with the first set of samples of at least one of video data and audio data.

21. The method of claim 19, further comprising storing the first set of samples in a file that conforms with at least one of:
an International Organization for Standardization (ISO) base media file format; and
a file format based on the ISO base media file format.

22. The method of claim 21, further comprising describing the first set of samples in a box that is an extension of the MetaDataSampleEntry box defined in the ISO base media file format.

23. The method of claim 19, further comprising defining the format of the first set of samples by an extensible markup language (XML) schema.

24. The method of claim 19, wherein the first set of samples and the at least one sample of information are transmitted to a network.

25. The method of claim 19, wherein at least one sample of information related to the position of the device and the orientation of the device contains audio-related metadata and is stored in a first metadata track, and wherein at least one additional sample of information related to the position of the device and the orientation of the device contains at least one of video-related metadata or additional audio-related metadata and is stored in a second metadata track.

26. The method of claim 25, wherein the first metadata track is referenced by a first track number and the second metadata track is referenced by a second track number, and wherein the first and second track numbers are stored in a box that is an extension of the MetaDataSampleEntry box defined in the ISO base media file format.

27. The method of claim 19, wherein at least one of the position of the device and the orientation of the device are recorded in a Media Presentation Description file.

28. The method of claim 19, wherein at least one of the position of the device and the orientation of the device are recorded in the Supplementary Enhancement Information (SEI) of a video coding format.
